(19) United States
(12) Patent Application Publication
(10) Pub. No.: US 2023/0073200 A1
(43) Pub. Date: Mar. 9, 2023

(54) APPARATUS AND METHOD FOR CONTROLLING A SHARED MEMORY IN A DATA PROCESSING SYSTEM

(71) Applicant: SK hynix Inc., Icheon-si (KR)

(72) Inventor: Gi Jo JEONG, Icheon-si (KR)

(21) Appl. No.: 17/592,425

(22) Filed: Feb. 3, 2022

(30) Foreign Application Priority Data
Sep. 6, 2021 (KR) 10-2021-0118270

(51) Int. Cl. G06F 3/06

(52) U.S. Cl. CPC G06F 3/0656; G06F 3/0659; G06F 3/0613; G06F 3/0604; G06F 3/0679

(57) ABSTRACT

A data processing system includes a host and a memory system. The host stores a program command in a submission queue and store program data corresponding to the program command in a host data buffer. The memory system communicates with the host and configured to obtain the program data stored in the host data buffer based on an operation status of an internal buffer, transmit an early completion signal to the host after obtaining the program data corresponding to the program command, and transmit, to the host, a release request for releasing the program data from the host data buffer.

### CROSS-REFERENCE TO RELATED APPLICATIONS

This patent document claims the benefit of Korean Patent Application No. 10-2021-0118270, filed on Sep. 6, 2021, the entire disclosure of which is incorporated herein by reference.

### TECHNICAL FIELD

The technology and implementations disclosed in this patent document relate to a data processing system, and particularly, to an apparatus and method for controlling shared memory regions in the data processing system.

### BACKGROUND

A data processing system includes a memory system or a data storage device. The data processing system can be developed to store more voluminous data in the data storage device, store data in the data storage device faster, and read data stored in the data storage device faster. The memory system or the data storage device can include non-volatile memory cells and/or volatile memory cells for storing data.

### SUMMARY

The technology disclosed in this patent document can be implemented in various embodiments.

One example of such embodiments is an implementation of a data processing system that comprises a host configured to store a program command in a submission queue and store program data corresponding to the program command in a host data buffer; and a memory system in communication with the host. The memory system may be configured to: obtain the program data stored in the host data buffer based on an operation status of an internal buffer; transmit an early completion signal to the host after obtaining the program data corresponding to the program command; and transmit, to the host, a release request for releasing the program data from the host data buffer.

Another example of the embodiments is an implementation of a memory system comprising: a storage device including plural non-volatile memory cells and configured to perform a data input/output operation; and a controller in communication with the storage device and an external device and configured to control the data input/output operation. The controller may be further configured to send an early completion signal to the external device in response to obtaining program data corresponding to a program command and send, to the external device, a release request for releasing the program data after the storage device completes a program operation regarding the program data.

### BRIEF DESCRIPTION OF THE DRAWINGS

The description herein makes reference to the accompanying drawings wherein like reference numerals refer to like parts throughout the figures.

FIG. 1 illustrates a data processing system according to an embodiment of the disclosed technology.

FIG. 2 illustrates a data processing system according to another embodiment of the disclosed technology.

FIG. 3 illustrates a memory system according to another embodiment of the disclosed technology.

FIG. 4 illustrates internal configuration included in a controller shown in FIGS. 1 to 3 according to embodiments of the disclosed technology.

FIG. 5 illustrates a first example of data input/output operations between a host and a memory system in a data processing system according to another embodiment of the disclosed technology.

FIG. 6 illustrates an example of accessing a memory in a host of a memory system according to another embodiment of the disclosed technology.

FIG. 7 illustrates a second example of data input/output operations between the host and the memory system in the data processing system according to another embodiment of the disclosed technology.

FIG. 8 illustrates a method of operating a memory system according to another embodiment of the disclosed technology.

FIG. 9 illustrates a method of operating a host according to another embodiment of the disclosed technology.

### DETAILED DESCRIPTION

Various embodiments of the disclosed technology are described below with reference to the accompanying drawings. Elements and features of the disclosure, however, may be configured or arranged differently to form other embodiments, which may be variations of any of the disclosed embodiments.

In this disclosure, references to various features (e.g., elements, structures, modules, components, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features may be included in one or more embodiments of the disclosed technology, but may or may not necessarily be combined in the same embodiments.

In this disclosure, the terms “comprise,” “comprising,” “include,” and “including” are open-ended. As used in the appended claims, these terms specify the presence of the stated elements and do not preclude the presence or addition of one or more other elements. The terms in a claim do not foreclose the apparatus from including additional components (e.g., an interface unit, circuitry, etc.).

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational (e.g., is not turned on nor activated). The block/unit/circuit/component used with the “configured to” language include hardware—for example, circuits, memory storing program instructions executable to implement the operation, etc. Additionally, “configured to” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

As used in this disclosure, the term ‘circuitry’ or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. This definition of ‘circuitry’ or ‘logic’ applies to all uses of this term in this application, including in any claims. As a further example, as used in this application, the term “circuitry” or “logic” also covers an implementation of merely a processor (or multiple processors) or portion of a processor and its (or their) accompanying software and/or firmware. The term “circuitry” or “logic” also covers, for example, and if applicable to a particular claim element, an integrated circuit for a storage device.

As used herein, the terms “first,” “second,” “third,” and so on are used as labels for nouns that they precede, and do not imply any type of ordering (e.g., spatial, temporal, logical, etc.). The terms “first” and “second” do not necessarily imply that the first value must be written before the second value. Further, although the terms may be used herein to identify various elements, these elements are not limited by these terms. These terms are used to distinguish one element from another element that otherwise have the same or similar names. For example, a first circuitry may be distinguished from a second circuitry.

Further, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

Herein, an item of data, a data item, a data entry or an entry of data may be a sequence of bits. For example, the data item may include the contents of a file, a portion of the file, a page in memory, an object in an object-oriented program, a digital message, a digital scanned image, a part of a video or audio signal, metadata or any other entity which can be represented by a sequence of bits. According to an embodiment, the data item may include a discrete object. According to another embodiment, the data item may include a unit of information within a transmission packet between two different components.

An embodiment of the disclosure provides a memory system, a data processing system, and an operation process or a method, which can quickly and reliably process data into a memory device by reducing operational complexity and performance degradation of the data processing system and the memory system thereby enhancing usage efficiency of the data processing system and the memory device.

An embodiment of the disclosure can provide a data processing system and a method for operating the data processing system. The data processing system includes components and resources such as a memory system and a host, and plural data paths used for data communication between the components based on usages of the components and the resources.

In an embodiment, a data processing system can include a host configured to store a program command in a submission queue and program data corresponding to the program command in a host data buffer; and a memory system in communication with the host and configured to: obtain the program data stored in the host data buffer based on an operation status of an internal buffer; transmit an early completion signal to the host after obtaining the program data corresponding to the program command; and transmit, to the host, a release request for releasing the program data from the host data buffer.

The host can include an application configured to generate the program command and the program data; and at least one input/output (I/O) core configured to control at least one pair of the submission queue and a completion queue corresponding to the submission queue, and control at least one pair of the host data buffer and a buffer release queue corresponding to the host data buffer.

The host can be configured to send a notification regarding the program command and the program data to the memory system. The at least one I/O core can be configured to support the memory system which gets information stored in the submission queue and the host data buffer and store other information in the completion queue and the buffer release queue. The at least one I/O core can transfer information stored in the submission queue and the host data buffer to the memory system. The at least one I/O core can be configured to release a command from the submission queue based on information stored in the completion queue, and release data from the host data buffer based on information stored in the buffer release queue.

The memory system can include a memory group including non-volatile memory cells; a controller configured to transfer the program data from the host to the memory group via data communication; and the internal buffer configured to temporarily store the program data.

The memory group can be configured to send a program completion signal regarding the program data in response to a completion of programming the program data in the non-volatile memory cells.

The controller can be configured to release the program data from the internal buffer in response to the program completion signal.

The controller can be configured to release the program data from the internal buffer after sending the program data to the memory group regardless of the program completion signal.

The controller can be configured to monitor an available space in the internal buffer for determining the operation status of the internal buffer.

In another embodiment, a memory system can include a storage device including plural non-volatile memory cells and configured to perform a data input/output operation; and a controller in communication with the storage device and an external device and configured to control the data input/output operation. The controller is further configured to send an early completion signal to the external device in response to obtaining program data, corresponding to a program command, included in the external device and send, to the external device, a release request for releasing the program data after the storage device completes a program operation regarding the program data.

The storage device can be configured to send a program completion signal regarding the program data after programming the program data in the plural non-volatile memory cells.

The controller can be further configured to release the program data from the internal buffer in response to the program completion signal.

The controller can be further configured to release the program data from the internal buffer after sending the program data to the memory group, regardless of the program completion signal.

The controller can be configured to store the early completion signal in a first region in the external device, and include the release request in a second region in the external device.

The controller can be further configured to monitor an available space of an internal memory to determine an operation state of the internal memory, and determine a timing that the program data is obtained from the external device in response to the operation state.

In another embodiment, a memory system can include a memory device, including plural non-volatile memory cells, configured to perform a data input/output operation; an internal memory configured to temporarily store data associated with the data input/output operation; and a controller configured to obtain a program command associated with program data from an external device, determine a timing of obtaining the program data from the external device based on an operation state of the internal memory, send an early completion signal regarding the program data to the external device, and send a release request for releasing the program data to the external device after the program data is programmed in the plural non-volatile memory cells.

The controller can be configured to: obtain the program command from a first region of the external device; obtain the program data from a second region of the external device; store the early completion signal in a third region of the external device; and store the release request in a fourth region of the external device.

The controller can be configured to monitor an available space in the internal buffer for determining the operation status of the internal buffer.

The controller can be further configured to release the program data from the internal buffer after sending the program data to the memory device, regardless of the program completion signal.

The controller can be further configured to release the program data from the internal buffer in response to the program completion signal.

The controller can be configured to send an early completion signal to the external device after obtaining the program data from the external device.

Embodiments of the disclosed technology will now be described with reference to the accompanying drawings, wherein like numbers reference like elements.

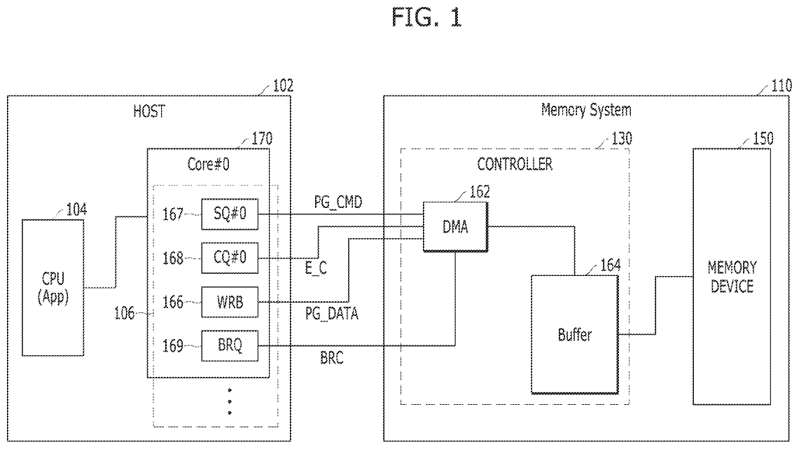

FIG. 1 illustrates a data processing system according to an embodiment of the disclosed technology.

Referring to FIG. 1, the data processing system 100 can include a host 102 and a memory system 110. The host 102 can include a computing device, a mobile device, or a network device. The memory system 110 can store data or output stored data according to a request input from the host 102. In FIG. 1, a computing device including a central processing unit (CPU) 104 or an application (App) 104 is shown as an example of the host 102, and a storage device (SSD) included in the computing device is shown as an example of the memory system 110. Internal configurations of the host 102 and the memory system 110 may vary according to an embodiment of the disclosed technology.

The host 102 and the memory system 110 can individually include an interface device capable of performing data communication therebetween. For example, the host 102 and the memory system 110 may include a PCI Express interface or an NVM Express (NVMe) interface. The NVM Express (NVMe) interface can include an extensible host controller interface designed to address needs of enterprise and client systems utilizing PCI Express-based solid-state drives. The host 102 may support a parallel processing regarding a plurality of data input/output operations.

The host 102 and the memory system 110 can support multi-path input/output (I/O) and namespace sharing. A namespace can correspond to a quantity of non-volatile memory that may be formatted into logical blocks. The host 102 can support accessing multiple namespaces referenced by namespace identifiers (IDs). The host 102 can use namespace management and attach namespace commands to create or delete namespaces. For example, the host 102 may use a namespace management command or a namespace connection command to create or delete a non-volatile memory region set as a specific namespace in the memory system 110.

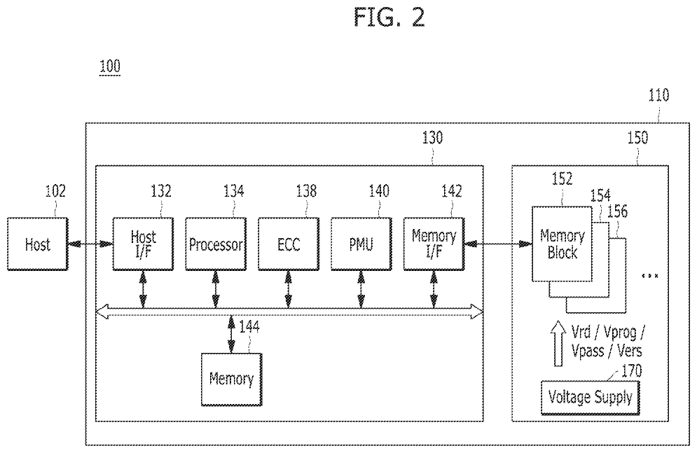

In some embodiments, the host 102 can include plural input/output cores. Herein, a core can be considered as one of multi-core processors shown in FIG. 2.

A first input/output core (Core #0) 170 can support data communication between the host 102 and the memory system 110. The data communication is performed based on a pair of queues including a submission queue (SQ) 167 and a completion queue (CQ) 168. A data input/output command (e.g., a read request or a write request) can be stored in the submission queue (SQ) 167 in the host 102, and a completion signal corresponding to the data input/output command can be stored in the completion queue (CQ) 168. The submission queue (SQ) 167 and the completion queue (CQ) 168 may be arranged or formed in the host memory 106 of the host 102.

An application or the central processing unit 104 of the host 102 can generate a command for performing a data input/output operation with the memory system 110, and the first input/output core (Core #0) 170 can include or store the command in the submission queue 167. The first input/output core (Core #0) 170 can transmit a command stored in the submission queue (SQ) 167 in response to a request from the memory system 110, or the memory system 110 can access the submission queue (SQ) 167 to get the command stored therein. Commands stored in the submission queue 167 can be sequentially transferred from the host 102 to the memory system 110 by the first input/output core (Core #0) 170. After getting the command from the host 102, the memory system 110 can perform a data input/output operation corresponding to the command, and send a completion signal corresponding to the command to the host 102. The completion signal can be stored in the completion queue (CQ) 168. The first input/output core (Core #0) 170 can release the command from the submission queue (SQ) 167 in response to the completion signal stored in the completion queue (CQ) 168. In some implementations, the controller is configured to send a release request from the memory system to release the command. In this case, the memory system 110 sends the release request corresponding to the command to the host 102 after the memory system 110 can perform the data input/output operation corresponding to the command. The first input/output core (Core #0) 170 can release the command from the submission queue (SQ) 167 in response to the release request received from the memory system 110.

An input/output (I/O) command set in data communication between the host 102 and the memory system 110 can be used with an input/output (I/O) queue pair. The first input/output core (Core #0) 170 in the host 102 can select one input/output (I/O) command set that is used for all input/output (I/O) queue pairs. An input/output (I/O) command set uses an input/output (I/O) queue pair. The host 102 can create queues up to a maximum supported for the data communication by the first input/output core (Core #0) 170. The host 102 can create a number of command queues based on a system configuration and an anticipated workload. Further, the host 102 can include a plurality of processor cores such as the first input/output core (Core #0) 170.

The submission queue (SQ) 167 can be a circular buffer with a fixed slot size that the host 102 uses to submit commands for execution by the first input/output cores (Core #0) 170 in the host 102. The first input/output cores (Core #0) 170 can update an appropriate SQ tail doorbell register when there are one to n new command to execute. The previous SQ Tail value can be overwritten in the first input/output cores (Core #0) 170 when there is a new doorbell register write. The first input/output cores (Core #0) 170 can fetch SQ entries in order from the submission queue (SQ) 167, however, it may then execute those commands in any order.

Each submission queue entry can be a command having a preset size. For example, commands are 64 bytes in size. Physical locations in the host memory 106 to use for data transfers are specified using Physical Region Page (PRP) entries or Scatter Gather Lists (SGL). Each command can include two PRP entries or one Scatter Gather List (SGL) segment. If more than two PRP entries are necessary to describe a write data buffer 166, then a pointer to a PRP List that can describe a list of PRP entries is provided. If more than one SGL segment is necessary to describe the write data buffer 166, then the SGL segment can provide a pointer to the next SGL segment.

The completion queue (CQ) 168 can be a circular buffer with a fixed slot size used to post status for completed commands. A completed command can be uniquely identified by a combination of the associated SQ identifier and command identifier that is assigned by the first input/output core (Core #0) 170. According to an embodiment, multiple submission queues SQs can be associated with a single completion queue CQ. For example, a single worker thread can process all command completions via the single completion queue CQ even when those commands originated from the multiple submission queues SQs. The CQ Head pointer can be updated by the first input/output core (Core #0) 170 after it has processed completion queue (CQ) entries indicating the last free CQ entry. A Phase bit is defined in the completion queue (CQ) entry to indicate whether an entry has been newly posted without consulting a register. This can enable the first input/output core (Core #0) 170 to determine whether the new entry was posted as part of the previous or current round of completion notifications. For example, each round through the completion queue (CQ) entries, the first input/output core (Core #0) 170 can invert the Phase bit.

In FIG. 1, the memory system 110 can include a controller 130 and a memory device 150. The memory device 150 can include a plurality of non-volatile memory cells capable of storing a data item transmitted by the host 102 or outputting a stored data item in response to a request input from the host 102. The controller 130 can be configured to control data input/output operations performed in the memory device 150 and perform data communication with the host 102. The controller 130 can include the data buffer 164 for storing data associated with a data input/output operation performed in the memory device 150. The controller 130 can include direct memory access (DMA) control circuitry 162 supporting direct memory access (DMA) in data communication with the host 102. The direct memory access (DMA) is a control scheme of a computer system that allows a specific hardware subsystem to access the host memory 106 independently of the central processing unit (CPU) or the application 104 in the host 102. In a Programmed input/output (PIO) method of exchanging data between a peripheral device such as a network adapter or an ATA storage device and a central processing unit, all data transmitted between components and devices may pass through the central processing unit 104. On the other hand, the direct memory access (DMA) control circuitry 162 can access the host memory 106 independently of the central processing unit (CPU) or the application 104, thereby improving data input/output performance of the data processing system.

The first input/output core (Core #0) 170 can set the submission queue (SQ) 167 and the completion queue (CQ) 168 in the host memory 106 of the host 102. The host memory 106 can further include the write data buffer (WRB) 166 that can be directly accessed by the memory system 110. The direct memory access (DMA) control circuitry 162 in the controller 130 can access the write data buffer (WRB) 166 in the host memory 106 and get program data PG_DATA stored in the write data buffer (WRB) 166, when recognizing an available space for storing program data in the data buffer 164 in the memory system 110. Internal resources in the memory system 110 may be limited because it might be difficult to add internal resources after the memory system 110 is manufactured. However, the host 102 may include more resources than the memory system 110, and it may be easy to add or change resources in the host 102 to improve operational performance. Accordingly, the direct memory access (DMA) control circuitry 162 in the controller 130 can utilize the write data buffer WRB 166 in the host memory 106 as another resource for improving performance of the memory system 110. The direct memory access (DMA) control circuitry 162 can determine or adjust a timing for bring or getting the program data PG_DATA for program operation executed in the memory device 150. This operation can allow the memory system 110 to overcome a limitation of internal resources and then improve data input/output performance.

For example, the CPU or application 104 of the host 102 can attempt to generate a large amount of data and store the large amount of data in the memory system 110. The first input/output core (Core #0) 170 (or at least one I/O core) of the host 102 can recognize plural program commands (PG_CMD) corresponding to the large amount of data in the submission queue (SQ) 167. According to an embodiment, an operation speed of the host 102 may be several to several thousand times faster than that of the memory system 110. Even though the first input/output core (Core #0) 170 recognizes a large number of program commands in the submission queue (SQ) 167, a data input/output speed of the memory system 110, in particular, a speed of program operation of the memory device 150 might be not fast, so that it is difficult for the first input/output core (Core #0) 170 to reduce entries stored in the submission queue (SQ) 167 at a fast speed. In addition, storage capacity of the host memory 106 can be tens to several thousand times greater than storage capacity of the data buffer 164 in the memory system 110. Therefore, even though the memory system 110 receives a large amount of data (i.e., the program data PG_DATA) from the host 102 and stores the large amount of data in the data buffer 164, a large number of program commands (PG_CMD) are remained in the submission queue (SQ) 167 until the large amount of data is programmed in the memory device 150. In this case, data input/output performance of the data processing system 100 is lowered due to a program operation speed of the memory system 110.

According to an embodiment, the controller 130 in the memory system 110 can fetch or get program data PG_DATA from the write data buffer WRB 166, which corresponds to a program command PG_CMD in the submission queue 167. Then, the controller 130 can be configured to send to the host 102 an early completion signal E_C regarding the program command PG_CMD before completing a program operation regarding the program data PG_DATA in the memory device 150. The early completion signal E_C can be added to the completion queue 168 in the host 102. In the memory system 110 including non-volatile memory cells, a time spent on an operation of programming data may be longer than a time spent on processing the data in the host 102. When the memory system 110 sends the early completion signal E_C regarding the program command PG_CMD to the host 102 in advance of program completion, the host 102 can recognize that data input/output operation of the memory system 110 is performed fast. Although the memory system 110 send the early completion signal E_C to the host 102 before the program data PG_DATA is not programmed in the memory device 150, the program data PG_DATA would be stored in the data buffer 164 or the write data buffer 166 of the host memory 106. Accordingly, even if an error occurs in the data buffer 164 of the memory system 110 or a program operation performed in the memory system 110, the controller 130 can get or obtain the corresponding program data PG_DATA from the write data buffer (WRB) 166 of the host 102 again, so that the program operation can be guaranteed.

According to an embodiment, when the memory system 110 adds the early completion signal E_C to the completion queue 168 of the host 102, the first input/output core (Core #0) 170 of the host 102 can check the early completion signal E_C included in the completion queue (CQ) 168 and recognize which program command is associated with the early completion signal E_C. The host 102 or the first input/output core (Core #0) 170 can release the program command PG_CMD from the submission queue SQ 167, based on the early completion signal E_C stored in the completion queue (CQ) 168. Even if the first input/output core (Core #0) 170 of the host 102 releases the program command PG_CMD from the submission queue 167, the program data PG_DATA corresponding to the released program command PG_CMD might not be deleted or released from in the write data buffer (WRB) 166.

According to an embodiment, when resources are secured and allocated for performing a program operation corresponding to the program command PG_CMD, the memory system 110 can add the early completion signal E_C into the completion queue 168 in the host 102. The memory system 110 can send the early completion signal E_C to the host 102 if the memory system 110 guarantees that program data corresponding to the program command PG_CMD is programmed in the memory device 150. The direct memory access (DMA) control circuitry 162 may bring or get the program data PG_DATA stored in the write data buffer 166 in the host memory 106 when there is an available space in the data buffer 164. Before transmitting the early completion signal E_C, the memory system 110 can get the program data PG_DATA from the write data buffer (WRB) 166 and store the program data PG_DATA in the data buffer 164. According to an embodiment, before transmitting the early completion signal E_C to the host 102, the controller 130 can send the program data PG_DATA stored in the data buffer 164 to the memory device 150. According to another embodiment, the controller 130 can send the early completion signal E_C to the host 102 even before sending the program data PG_DATA stored in the data buffer 164 to the memory device 150, if it would be guaranteed that the program data PG_DATA is programmed in non-volatile memory cells of the memory device 150.

After the memory device 150 programs the program data PG_DATA in the non-volatile memory cells, the memory device 150 can notify the controller 130 that the program operation is complete. The controller 130 may add a buffer release request BRC into the buffer release queue (BRQ) 169 in the host memory 106, in response to a program completion of the memory device 150. The buffer release request BRC is sent by the controller 130, if the corresponding program data PG_DATA is programmed in the memory device 150.

The buffer release queue (BRQ) 169 in the host memory 106 may be used to release the program data PG_DATA stored in the program data buffer 166 in the host memory 106. Because the memory system 110 sends the early completion signal E_C to the host 102 before completing the program operation, the host 102 may not release the program data PG_DATA from the write data buffer 166 of the host memory 106, in response to the early completion signal E_C.

If a storage space of the data buffer 164 in the memory system 110 is sufficient and the program data PG_DATA can be safely kept until the program data PG_DATA is programmed in the memory device 150, the host 102 may release the program data PG_DATA from the write data buffer 166 in response to the early completion signal E_C input to the host 102. The memory system 110 may use the early completion signal E_C to more quickly perform the data input/output operation requested by the host 102 while more efficiently using the resources included in the host 102 with the limitation on the resources in the memory system 100. When the early completion signal E_C is included in the completion queue 168, the host 102 can release the program command PG_CMD included in the submission queue 167 while not releasing the program data PG_DATA from the write data buffer (WRB) 166. Accordingly, the program data PG_DATA is not released from the write data buffer (WRB) 166 in response to the early completion signal E_C.

After completing a program operation regarding the program data PG_DATA, the memory system 110 can add a buffer release request BRC into the buffer release queue (BRQ) 169. The first input/output core 170 of the host 102 can check the buffer release request BRC included in the buffer release queue (BRQ) 169, and release the program data PG_DATA corresponding to the buffer release request BRC from the write data buffer (WRB) 166.

In some embodiments, after the controller 130 in the memory system 110 transmits the program data PG_DATA corresponding to the program operation to the memory device 150, the controller 130 can release the corresponding program data PG_DATA from the data buffer 164 before the memory device 150 completes the program operation regarding the program data PG_DATA. In this case, an available space of the data buffer 164 in the memory system 110 can be used to store other program data or other operation information. However, when the controller 130 releases the program data PG_DATA from the data buffer 164 before the memory device 150 sends the completion of the program operation to the controller 130, an error can occur in the program operation performed in the memory device 150. To recover the error, the direct memory access (DMA) control circuitry 162 may access and get the program data PG_DATA stored in the write data buffer (WRB) 166 in the host memory 106 again.

According to an embodiment, the controller 130 in the memory system 110 can maintain (not release) the program data PG_DATA stored in the data buffer 164 until the memory device 150 completes the program operation regarding the program data PG_DATA. In this case, even if an error occurs in the program operation, the controller 130 can transmit the program data PG_DATA stored in the data buffer 164 to the memory device 150 again without accessing the program data PG_DATA in the host memory 106.

As described above, after the memory system 110 gets or obtains the program command PG_CMD stored in the submission queue (SQ) 167 which is established by the host 102, available resources in the memory system 110 are secured for performing the program operation regarding the program data PG_DATA stored in the write data buffer 166 in the host memory 106, and then the memory system 110 can retrieve the program data PG_DATA. In the memory system 110, there is a timing difference between getting or obtaining the program command PG_CMD included in the submission queue 167 and the program data PG_DATA, corresponding to the program command PG_CMD, stored in the program data buffer 166.

Further, the memory system 110 can send the early completion signal E_C to the completion queue 168 after obtaining the program data PG_DATA corresponds to the program command PG_CMD stored in the write data buffer (WRB) 166. A timing of sending the early completion signal E_C might be earlier than a timing of completing the program operation regarding the program data PG_DATA in the memory device 150. Accordingly, it is difficult for the host 102 to control the write data buffer (WRB) 166 based on the early completion signal E_C added into the completion queue 168. In an embodiment, the host 102 can establish a buffer release queue 169 in the host memory 106, and the memory system 110 can send a buffer release request (BRC) to the buffer release queue 169. The host 102 can control and manage the write data buffer 166 based on an entry in the buffer release queue 169.

The memory system 110 can utilize the host memory 106 in host 102 to overcome a limitation on internal resources in the memory system 110. In addition, it is shown that data input/output commands requested by the CPU or application 104 in the host 102 is performed quickly, because the data input/output commands can be released from the submission queues (SQ) 167. In this procedure, the host 102 and the memory system 110 may use different queues to controls (e.g., retain or release) data input/output commands and data corresponding to the data input/output commands. Accordingly, the host 102 can also more efficiently control and manage resources of the host memory 106.

An embodiment of the disclosed technology can be applicable to the data processing system where a speed of data communication for exchanging commands or data between the host and the memory system is faster than that of data input/output operations performed in the memory system. The memory system can use a shared memory, or a shared memory region, included in the host, to reduce or avoid a bottleneck of data communication between the host and the memory system, which may be caused by limitation of resources for processing host's command. Specifically, the memory system can check a write request (or a program command) and program data to be transmitted from the host, and determine whether to bring or get the program data stored in the host to a data buffer included in the memory system or move the program data to the shared memory region in the host, in response to an operational state of the data buffer.

In response to a write request generated by the host, the memory system may transmit, to the host, a first release signal indicating whether it is guaranteed to complete an operation corresponding to the write request and program data and a second release signal indicating whether the operation corresponding to the write request and program data has been completed. The host can manage and control a host memory in response to two different release signals transmitted by the memory system, thereby increasing efficiency and reducing an overhead of memory management. The memory system can send a signal or a request to release information or data stored in a shared memory provided by the host, so the memory system can have transparency in controlling the shared memory region included in the host, and the host can clearly monitor an operation status of the shared memory region. In response to the operation state of the shared memory region, the host can attempt to allocate an additional region for the shared memory region or convert some of the shared memory for other usages, thereby improving availability of resources included in the host.

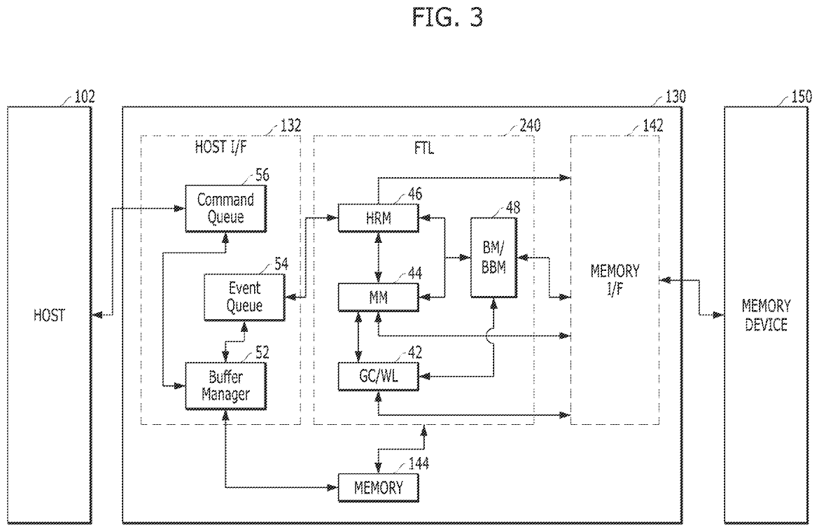

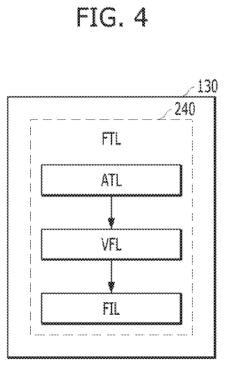

Hereinafter, descriptions will be made focusing on operations or components that can be technically distinguished between the controller 130 and the memory device 150 described in FIG. 1 and FIGS. 2 to 4. Specifically, a flash translation layer (FTL) 240 in the controller 130 will be described in more detail with reference to FIGS. 3 to 4. According to an embodiment, roles and functions of the flash translation layer (FTL) in the controller 130 may be varied.

FIGS. 2 and 3 illustrate some operations that may be performed by the memory system 110 according to one or more embodiments of the disclosed technology.

Referring to FIG. 2, the data processing system 100 may include a host 102 engaged or coupled with a memory system, such as memory system 110. For example, the host 102 and the memory system 110 can be coupled to each other via a data bus, a host cable and the like to perform data communication.

The memory system 110 may include a memory device 150 and a controller 130. The memory device 150 and the controller 130 in the memory system 110 may be considered components or elements physically separated from each other. The memory device 150 and the controller 130 may be connected via at least one data path. For example, the data path may include a channel and/or a way.

According to an embodiment, the memory device 150 and the controller 130 may be components or elements functionally divided. In some embodiments, the memory device 150 and the controller 130 may be implemented with a single chip or different chips. The controller 130 may perform a data input/output operation in response to a request input from the external device. For example, when the controller 130 performs a read operation in response to a read request input from an external device, data stored in a plurality of non-volatile memory cells included in the memory device 150 is transferred to the controller 130.

As shown in FIG. 2, the memory device 150 may include a plurality of memory blocks 152, 154, 156. The memory block 152, 154, 156 may be understood as a group of non-volatile memory cells in which data is removed together by a single erase operation. Although not illustrated, the memory block 152, 154, 156 may include a page which is a group of non-volatile memory cells that store data together during a single program operation or output data together during a single read operation. For example, one memory block may include a plurality of pages.

For example, the memory device 150 may include a plurality of memory planes or a plurality of memory dies. According to an embodiment, the memory plane may be considered a logical or a physical partition including at least one memory block, a driving circuit capable of controlling an array including a plurality of non-volatile memory cells, and a buffer that can temporarily store data inputted to, or outputted from, non-volatile memory cells.

In addition, according to an embodiment, the memory die may include at least one memory plane. The memory die may be understood as a set of components implemented on a physically distinguishable substrate. Each memory die may be connected to the controller 130 through a data path. Each memory die may include an interface to exchange an item of data and a signal with the controller 130.

According to an embodiment, the memory device 150 may include at least one memory block 152, 154, 156, at least one memory plane, or at least one memory die. The internal configuration of the memory device 150 shown in FIGS. 1 and 2 may be different according to performance of the memory system 110. An embodiment of the disclosed technology is not limited to the internal configuration shown in FIG. 2.

Referring to FIG. 2, the memory device 150 may include a voltage supply circuit 170 capable of supplying at least some voltage into the memory block 152, 154, 156. The voltage supply circuit 170 may supply a read voltage Vrd, a program voltage Vprog, a pass voltage Vpass, or an erase voltage Vers into a non-volatile memory cell included in the memory block. For example, during a read operation for reading data stored in the non-volatile memory cell included in the memory block 152, 154, 156, the voltage supply circuit 170 may supply the read voltage Vrd into a selected non-volatile memory cell. During the program operation for storing data in the non-volatile memory cell included in the memory block 152, 154, 156, the voltage supply circuit 170 may supply the program voltage Vprog into a selected non-volatile memory cell. Also, during a read operation or a program operation performed on the selected nonvolatile memory cell, the voltage supply circuit 170 may supply a pass voltage Vpass into a non-selected nonvolatile memory cell. During the erasing operation for erasing data stored in the non-volatile memory cell included in the memory block 152, 154, 156, the voltage supply circuit 170 may supply the erase voltage Vers into the memory block.

The memory device 150 may store information regarding various voltages which are supplied to the memory block 152, 154, 156 based on which operation is performed. For example, when a non-volatile memory cell in the memory block 152, 154, 156 can store multi-bit data, plural levels of the read voltage Vrd for recognizing or reading the multi-bit data item may be required. The memory device 150 may include a table including information corresponding to plural levels of the read voltage Vrd, corresponding to the multi-bit data item. For example, the table can include bias values stored in a register, each bias value corresponding to a specific level of the read voltage Vrd. The number of bias values for the read voltage Vrd that is used for a read operation may be limited to a preset range. Also, the bias values can be quantized.

The host 102 may include a portable electronic device (e.g., a mobile phone, an MP3 player, a laptop computer, etc.) or a non-portable electronic device (e.g., a desktop computer, a game player, a television, a projector, etc.).

The host 102 may also include at least one operating system (OS), which can control functions and operations performed in the host 102. The OS can provide interoperability between the host 102 engaged operatively with the memory system 110 and a user who intends to store data in the memory system 110. The OS may support functions and operations corresponding to user's requests. By way of example but not limitation, the OS can be classified into a general operating system and a mobile operating system according to mobility of the host 102. The general operating system may be split into a personal operating system and an enterprise operating system according to system requirements or a user environment. As compared with the personal operating system, the enterprise operating systems can be specialized for securing and supporting high performance computing.

The mobile operating system may be subject to support services or functions for mobility (e.g., a power saving function). The host 102 may include a plurality of operating systems. The host 102 may execute multiple operating systems interlocked with the memory system 110, corresponding to a user's request. The host 102 may transmit a plurality of commands corresponding to the user's requests into the memory system 110, thereby performing operations corresponding to the plurality of commands within the memory system 110.

A controller 130 in the memory system 110 may control a memory device 150 in response to a request or a command input from the host 102. For example, the controller 130 may perform a read operation to provide data read from the memory device 150 to the host 102 and may perform a write operation (or a program operation) to store data input from the host 102 in the memory device 150. In order to perform data input/output (I/O) operations, the controller 130 may control and manage internal operations of reading data, programming data, erasing data, or the like.

According to an embodiment, the controller 130 may include a host interface 132, a processor 134, error correction circuitry (ECC) 138, a power management unit (PMU) 140, a memory interface 142, and a memory 144. Components included in the controller 130 as illustrated in FIG. 2 may vary according to structures, functions, operation performance, or the like, regarding the memory system 110.

For example, the memory system 110 may be implemented with any of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like. Components may be added to or omitted from the controller 130 according to implementation of the memory system 110.

The host 102 and the memory system 110 each may include a controller or an interface for transmitting and receiving signals, data, and the like, in accordance with one or more predetermined protocols. For example, the host interface 132 in the memory system 110 may include an apparatus capable of transmitting signals, data, and the like to the host 102 or receiving signals, data, and the like from the host 102.

The host interface 132 included in the controller 130 may receive signals, commands (or requests), and/or data input from the host 102 via a bus. For example, the host 102 and the memory system 110 may use a predetermined set of rules or procedures for data communication or a preset interface to transmit and receive data therebetween. Examples of sets of rules or procedures for data communication or interfaces supported by the host 102 and the memory system 110 for sending and receiving data include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIe or PCI-e), Serial-attached SCSI (SAS), Serial Advanced Technology Attachment (SATA), Mobile Industry Processor Interface (MIPI), and the like. According to an embodiment, the host interface 132 is a type of layer for exchanging data with the host 102 and is implemented with, or driven by, firmware called a host interface layer (HIL). According to an embodiment, the host interface 132 can include a command queue.

The Integrated Drive Electronics (IDE) or Advanced Technology Attachment (ATA) may be used as one of the interfaces for transmitting and receiving data and, for example, may use a cable including 40 wires connected in parallel to support data transmission and data reception between the host 102 and the memory system 110. When a plurality of memory systems 110 are connected to a single host 102, the plurality of memory systems 110 may be divided into a master and a slave by using a position or a dip switch to which the plurality of memory systems 110 are connected. The memory system 110 set as the master may be used as a main memory device. The IDE (ATA) may include, for example, Fast-ATA, ATAPI, or Enhanced IDE (EIDE).

A Serial Advanced Technology Attachment (SATA) interface is a type of serial data communication interface that is compatible with various ATA standards of parallel data communication interfaces which are used by Integrated Drive Electronics (IDE) devices. The 40 wires in the IDE interface can be reduced to six wires in the SATA interface. For example, 40 parallel signals for the IDE can be converted into 6 serial signals for the SATA interface. The SATA interface has been widely used because of its faster data transmission and reception rate and its less resource consumption in the host 102 used for the data transmission and reception. The SATA interface may connect up to 30 external devices to a single transceiver included in the host 102. In addition, the SATA interface can support hot plugging that allows an external device to be attached to or detached from the host 102, even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely attached to or detached from the host 102 like an external hard disk.

Small Computer System Interface (SCSI) is a type of serial data communication interface used for connecting a computer or a server with other peripheral devices. The SCSI can provide a high transmission speed, as compared with other interfaces such as IDE and SATA. In the SCSI, the host 102 and at least one peripheral device (e.g., memory system 110) are connected in series, but data transmission and reception between the host 102 and each peripheral device may be performed through a parallel data communication. In the SCSI, it is easy to connect or disconnect a device such as the memory system 110 to or from the host 102. The SCSI can support connections of 15 other devices to a single transceiver included in host 102.

Serial Attached SCSI (SAS) can be understood as a serial data communication version of the SCSI. In the SAS, the host 102 and a plurality of peripheral devices are connected in series, and data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-volatile memory express (NVMe) is a kind of interface based at least on a Peripheral Component Interconnect Express (PCIe) designed to increase performance and design flexibility of the host 102, servers, computing devices, and the like equipped with the non-volatile memory system 110. The PCIe can use a slot or a specific cable for connecting a computing device (e.g., host 102) and a peripheral device (e.g., memory system 110). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second (e.g., 250 MB/s, 500 MB/s, 984.6250 MB/s, or 1969 MB/s). According to an embodiment, the PCIe scheme may achieve bandwidths of tens to hundreds of Giga bits per second. The NVMe can support an operation speed of the non-volatile memory system 110, such as an SSD, that is faster than a hard disk.

According to an embodiment, the host 102 and the memory system 110 may be connected through a universal serial bus (USB). The Universal Serial Bus (USB) is a type of scalable, hot-pluggable plug-and-play serial interface that can provide cost-effective standard connectivity between the host 102 and peripheral devices such as a keyboard, a mouse, a joystick, a printer, a scanner, a storage device, a modem, a video camera, and the like. A plurality of peripheral devices such as the memory system 110 may be coupled to a single transceiver included in the host 102.

Referring to FIG. 2, the error correction circuitry 138 can correct error bits of data read from the memory device 150, and may include an error correction code (ECC) encoder and an ECC decoder. The ECC encoder may perform error correction encoding of data to be programmed in the memory device 150 to generate encoded data into which a parity bit is added, and store the encoded data in the memory device 150. The ECC decoder can detect and correct error bits contained in the data read from the memory device 150 when the controller 130 reads the data stored in the memory device 150. For example, after performing error correction decoding on the data read from the memory device 150, the error correction circuitry 138 determines whether the error correction decoding has succeeded or not, and outputs an instruction signal (e.g., a correction success signal or a correction fail signal), based on a result of the error correction decoding. The error correction circuitry 138 may use a parity bit, which has been generated during the ECC encoding process for the data stored in the memory device 150, in order to correct the error bits of the read data. When the number of the error bits is greater than or equal to the number of correctable error bits, the error correction circuitry 138 may not correct the error bits and instead may output the correction fail signal indicating failure in correcting the error bits.

According to an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), or the like. The error correction circuitry 138 may include all circuits, modules, systems, and/or devices for performing the error correction operation based on at least one of the above described codes. The error correction circuitry 138 shown in FIG. 2 can include at least some of the components included in the controller 130 shown in FIG. 1.

For example, the ECC decoder may perform hard decision decoding or soft decision decoding on data transmitted from the memory device 150. The hard decision decoding can be understood as one of two methods broadly classified for error correction. The hard decision decoding may include an operation of correcting an error bit by reading digital data of ‘0’ or ‘1’ from a non-volatile memory cell in the memory device 150. Because the hard decision decoding handles a binary logic signal, the circuit/algorithm design or configuration may be simpler and a processing speed may be faster than the soft decision decoding.

The soft decision decoding may quantize a threshold voltage of a non-volatile memory cell in the memory device 150 by two or more quantized values (e.g., multiple bit data, approximate values, an analog value, and the like) in order to correct an error bit based on the two or more quantized values. The controller 130 can receive two or more alphabets or quantized values from a plurality of non-volatile memory cells in the memory device 150, and then perform a decoding based on information generated by characterizing the quantized values as a combination of information such as conditional probability or likelihood.

According to an embodiment, the ECC decoder may use a low-density parity-check and generator matrix (LDPC-GM) code among methods designed for the soft decision decoding. The low-density parity-check (LDPC) code uses an algorithm that can read values of data from the memory device 150 in several bits according to reliability, not simply data of 1 or 0 like the hard decision decoding, and iteratively repeats it through a message exchange in order to improve reliability of the values. Then, the values are finally determined as data of 1 or 0. For example, a decoding algorithm using LDPC codes can be understood as probabilistic decoding. The hard decision decoding in which a value output from a non-volatile memory cell is coded as 0 or 1. Compared to the hard decision decoding, the soft decision decoding can determine the value stored in the non-volatile memory cell based on the stochastic information. Regarding bit-flipping which may be considered an error that can occur in the memory device 150, the soft decision decoding may provide improved probability of correcting the error and recovering data, as well as providing reliability and stability of corrected data. The LDPC-GM code may have a scheme in which internal LDGM codes can be concatenated in series with high-speed LDPC codes.

According to an embodiment, the ECC decoder may use, for example, low-density parity-check convolutional codes (LDPC-CCs) for the soft decision decoding. The LDPC-CCs may have a scheme using a linear time encoding and a pipeline decoding based on a variable block length and a shift register.

According to an embodiment, the ECC decoder may use, for example, a Log Likelihood Ratio Turbo Code (LLR-TC) for the soft decision decoding. A Log Likelihood Ratio (LLR) may be calculated as a non-linear function for a distance between a sampled value and an ideal value. In addition, a Turbo Code (TC) may include a simple code (for example, a Hamming code) in two or three dimensions and repeat decoding in a row direction and a column direction to improve reliability of values.

The power management unit (PMU) 140 may control electrical power provided to the controller 130. The PMU 140 may monitor the electrical power supplied to the memory system 110 (e.g., a voltage supplied to the controller 130) and provide the electrical power to components included in the controller 130. The PMU 140 may not only detect power-on or power-off, but also generate a trigger signal to enable the memory system 110 to urgently back up a current state when the electrical power supplied to the memory system 110 is unstable. According to an embodiment, the PMU 140 may include a device or a component capable of accumulating electrical power that may be used in an emergency.

The memory interface 142 may serve as an interface for handling commands and data transferred between the controller 130 and the memory device 150, in order to allow the controller 130 to control the memory device 150 in response to a command or a request input from the host 102. The memory interface 142 may generate a control signal for the memory device 150 and may process data input to, or output from, the memory device 150 under the control of the processor 134 in a case when the memory device 150 is a flash memory.

For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) for exchanging data with the memory device 150. The memory interface 142 can include the execution queue 180 or the plurality of group queues 182, 184, 186 shown in FIG. 1.

According to an embodiment, the memory interface 142 may support an open NAND flash interface (ONFi), a toggle mode, or the like, for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), a toggle double data rate (DDR), or the like.

The memory 144 may be used as a working memory of the memory system 110 or the controller 130, while temporarily storing transactional data of operations performed in the memory system 110 and the controller 130. For example, the memory 144 may temporarily store read data output from the memory device 150 in response to a read request from the host 102 before the read data is output to the host 102. In addition, the controller 130 may temporarily store write data input from the host 102 in the memory 144 before programming the write data in the memory device 150. When the controller 130 controls operations, such as a data read operation, a data write or program operation, a data erase operation, etc., of the memory device 150, data transmitted between the controller 130 and the memory device 150 of the memory system 110 may be temporarily stored in the memory 144. For example, the memory 144 can include the data buffer 164 shown in FIG. 1.

In addition to the read data or write data, the memory 144 may store information (e.g., map data, read requests, program requests, etc.) used for inputting or outputting data between the host 102 and the memory device 150. According to an embodiment, the memory 144 may include one or more of a command queue, a program memory, a data memory, a write buffer/cache, a read buffer/cache, a data buffer/cache, a map buffer/cache, and so on. The controller 130 may allocate some storage space in the memory 144 for a component which is established to carry out a data input/output operation. For example, the write buffer established in the memory 144 may be used to temporarily store target data subject to a program operation.

In an embodiment, the memory 144 may be implemented with a volatile memory. For example, the memory 144 may be implemented with a static random access memory (SRAM), a dynamic random access memory (DRAM), or both. Although FIG. 2 illustrates, for example, the memory 144 disposed within the controller 130, embodiments are not limited thereto. The memory 144 may be located within or external to the controller 130. For instance, the memory 144 may be embodied by an external volatile memory having a memory interface transferring data and/or signals between the memory 144 and the controller 130.

The processor 134 may control the overall operations of the memory system 110. For example, the processor 134 can control a program operation or a read operation of the memory device 150 in response to a write request or a read request entered from the host 102. According to an embodiment, the processor 134 may execute firmware to control the program operation or the read operation in the memory system 110. Herein, the firmware may be referred to as a flash translation layer (FTL). An example of the FTL will be described in detail, referring to FIGS. 3 and 4. According to an embodiment, the processor 134 may be implemented with a microprocessor, a central processing unit (CPU), or the like.

According to an embodiment, the memory system 110 may be implemented with at least one multi-core processor. The multi-core processor is a type of circuit or chip in which two or more cores, which are considered distinct processing regions, are integrated. For example, when a plurality of cores in the multi-core processor drive or execute a plurality of flash translation layers (FTLs) independently, a data input/output speed (or performance) of the memory system 110 may be improved. According to an embodiment, the data input/output (I/O) operations in the memory system 110 may be independently performed through different cores in the multi-core processor.

The processor 134 in the controller 130 may perform an operation corresponding to a request or a command input from the host 102. Further, the memory system 110 may perform an operation independent from a command or a request input from the host 102. In one case, an operation performed by the controller 130 in response to the request or the command input from the host 102 may be considered a foreground operation, while an operation performed by the controller 130 independently from the request or the command input from the host 102 may be considered a background operation. The controller 130 can perform foreground or background operations for reading, writing, or erasing data in the memory device 150. In addition, a parameter set operation corresponding to a set parameter command or a set feature command as a set command transmitted from the host 102 may be considered a foreground operation. As a background operation that is performed without a command transmitted from the host 102, the controller 130 can perform garbage collection (GC), wear leveling (WL), bad block management for identifying and processing bad blocks, or the like.

According an embodiment, substantially similar operations may be performed as both the foreground operation and the background operation. For example, when the memory system 110 performs garbage collection in response to a request or a command input from the host 102 (e.g., Manual GC), the garbage collection can be considered a foreground operation. When the memory system 110 performs garbage collection independently of the host 102 (e.g., Auto GC), the garbage collection can be considered a background operation.

When the memory device 150 includes a plurality of dies (or a plurality of chips) each including a plurality of non-volatile memory cells, the controller 130 may perform parallel processing regarding plural requests or commands input from the host 102 in order to improve performance of the memory system 110. For example, the transmitted requests or commands may be divided into plural groups including at least some of a plurality of planes, a plurality of dies, or a plurality of chips included in the memory device 150, and the plural groups of requests or commands are processed individually or in parallel in each plane, each die or each chip.

The memory interface 142 in the controller 130 may be connected to the plurality of dies or chips in the memory device 150 through at least one channel and at least one way. When the controller 130 distributes and stores data in the plurality of dies through each channel or each way in response to requests or commands associated with a plurality of pages including non-volatile memory cells, a plurality of operations corresponding to the requests or the commands can be performed simultaneously or in parallel in the plurality of dies or planes. Such a processing method or scheme can be considered as an interleaving method. Because a data input/output speed of the memory system 110 increases by operating with the interleaving method, data I/O performance of the memory system 110 can be improved.

By way of example but not limitation, the controller 130 can recognize statuses of a plurality of channels (or ways) associated with the plurality of dies included in the memory device 150. The controller 130 may determine a status of each channel or each way as one of a busy status, a ready status, an active status, an idle status, a normal status, and an abnormal status. The determination of which channel or way an instruction (and/or a data) is delivered through by the controller can be associated with a physical block address. The controller 130 may refer to descriptors delivered from the memory device 150. The descriptors may include a block or page of parameters describing something about the memory device 150. The descriptors can have a predetermined format or structure. For instance, the descriptors may include device descriptors, configuration descriptors, unit descriptors, and the like. The controller 130 may refer to, or use, the descriptors to determine which channel(s) or way(s) is used to exchange an instruction or data.

Referring to FIG. 2, the memory device 150 in the memory system 110 may include a plurality of memory blocks 152, 154, 156. Each of the plurality of memory blocks 152, 154, 156 includes a plurality of non-volatile memory cells. According to an embodiment, the memory block 152, 154, 156 can be a group of non-volatile memory cells erased together. The memory block 152, 154, 156 may include a plurality of pages which is a group of non-volatile memory cells read or programmed together.

In one embodiment, each memory block 152, 154, or 156 may have a three-dimensional stack structure for a high integration. Further, the memory device 150 may include a plurality of dies, each die including a plurality of planes, each plane including the plurality of memory blocks 152, 154, 156. A configuration of the memory device 150 may be changed depending on performance of the memory system 110.

FIG. 2 illustrates the memory device 150 that includes the plurality of memory blocks 152, 154, and 156. The plurality of memory blocks 152, 154, and 156 may be any of single-level cell (SLC) memory blocks, multi-level cell (MLC) memory blocks, or the like, according to the number of bits that can be stored in one memory cell. An SLC memory block includes a plurality of pages implemented by memory cells, each memory cell storing one bit of data. An SLC memory block may have higher data I/O operation performance and higher durability than the MLC memory block. The MLC memory block includes a plurality of pages implemented by memory cells, each memory cell storing multi-bit data (e.g., two or more bits of data). The MLC memory block may have larger storage capacity for the same space compared to the SLC memory block. The MLC memory block can be highly integrated in a view of storage capacity.

In an embodiment, the memory device 150 may be implemented with MLC memory blocks such as a double level cell (DLC) memory block, a triple-level cell (TLC) memory block, a quadruple-level cell (QLC) memory block, and a combination thereof. The DLC memory block may include a plurality of pages implemented by memory cells, each memory cell capable of storing 2-bit data. The TLC memory block can include a plurality of pages implemented by memory cells, each memory cell capable of storing 3-bit data. The QLC memory block can include a plurality of pages implemented by memory cells, each memory cell capable of storing 4-bit data. In another embodiment, the memory device 150 can be implemented with a block including a plurality of pages implemented by memory cells, each memory cell capable of storing five or more bits of data.

According to an embodiment, the controller 130 may use a MLC memory block included in the memory device 150 as an SLC memory block that stores one-bit data in one memory cell. A data input/output speed of the multi-level cell (MLC) memory block can be slower than that of the SLC memory block. That is, when the MLC memory block is used as the SLC memory block, a margin for a read or program operation can be reduced. For example, the controller 130 may perform a data input/output operation with a higher speed when the MLC memory block is used as the SLC memory block. Thus, the controller 130 may use the MLC memory block as a SLC buffer to temporarily store data because the buffer may require a high data input/output speed for improving performance of the memory system 110.

Further, according to an embodiment, the controller 130 can program data in a MLC a plurality of times without performing an erase operation on a specific MLC memory block included in the memory device 150. In general, non-volatile memory cells do not support data overwrite. However, the controller 130 may program 1-bit data in the MLC a plurality of times using a feature in which the MLC is capable of storing multi-bit data. For a MLC overwrite operation, the controller 130 may store the number of program times as separate operation information when 1-bit data is programmed in a MLC. According to an embodiment, an operation for uniformly levelling threshold voltages of the MLCs may be carried out before another 1-bit data is programmed in the same MLCs, each having stored another-bit data.

In an embodiment, the memory device 150 is embodied as a non-volatile memory such as a flash memory, for example, as a NAND flash memory, a NOR flash memory, or the like. In another embodiment, the memory device 150 may be implemented by at least one of a phase change random access memory (PCRAM), a ferroelectrics random access memory (FRAM), a transfer torque random access memory (STT-RAM), and a spin transfer torque magnetic random access memory (STT-MRAM), or the like.

Referring to FIG. 3, the controller 130 in a memory system operates along with the host 102 and the memory device 150. As illustrated, the controller 130 includes the host interface 132, a flash translation layer (FTL) 240, the memory interface 142, and the memory 144 previously identified with reference to FIG. 2.

According to an embodiment, the error correction circuitry 138 illustrated in FIG. 2 may be included in the flash translation layer (FTL) 240. In another embodiment, the error correction circuitry 138 may be implemented as a separate module, a circuit, firmware, or the like, which is included in or associated with the controller 130.

The host interface 132 may handle commands, data, and the like transmitted from the host 102. By way of example but not limitation, the host interface 132 may include a command queue 56, a buffer manager 52, and an event queue 54. The command queue 56 may sequentially store the commands, the data, and the like received from the host 102, and output them to the buffer manager 52, for example, in an order in which they are stored in the command queue 56. The buffer manager 52 may classify, manage, or adjust the commands, the data, and the like received from the command queue 56. The event queue 54 may sequentially transmit events for processing the commands, the data, and the like received from the buffer manager 52. For example, the host interface 132 can include the direct memory access (DMA) control circuitry 162 shown in FIG. 1.

A plurality of commands or data of the same characteristic may be transmitted from the host 102, or a plurality of commands and data of different characteristics may be transmitted to the memory system 110 after being mixed or jumbled by the host 102. For example, a plurality of commands for reading data, i.e., read commands, may be delivered, or a commands for reading data, i.e., a read command, and a command for programming/writing data, i.e., a write command, may be alternately transmitted to the memory system 110. The host interface 132 may sequentially store commands, data, and the like, which are transmitted from the host 102, in the command queue 56. Thereafter, the host interface 132 may estimate or predict what type of internal operations the controller 130 will perform according to the characteristics of the commands, the data, and the like, which have been transmitted from the host 102. The host interface 132 may determine a processing order and a priority of commands, data and the like based on their characteristics.

According to the characteristics of the commands, the data, and the like transmitted from the host 102, the buffer manager 52 in the host interface 132 is configured to determine whether the buffer manager 52 should store the commands, the data, and the like in the memory 144, or whether the buffer manager 52 should deliver the commands, the data, and the like to the flash translation layer (FTL) 240. The event queue 54 receives events, transmitted from the buffer manager 52, which are to be internally executed and processed by the memory system 110 or the controller 130 in response to the commands, the data, and the like, and delivers the events to the flash translation layer (FTL) 240 in the order of the events input to the event queue 54.

In accordance with an embodiment, the flash translation layer (FTL) 240 illustrated in FIG. 3 may implement a multi-thread scheme to perform data input/output (I/O) operations. A multi-thread FTL may be implemented through a multi-core processor using multi-thread included in the controller 130.

In accordance with an embodiment, the flash translation layer (FTL) 240 may include a host request manager (HRM) 46, a map manager (MM) 44, a state manager 42, and a block manager 48. The host request manager (HRM) 46 may manage the events transmitted from the event queue 54. The map manager (MM) 44 may handle or control map data. The state manager 42 may perform garbage collection (GC) or wear leveling (WL). The block manager 48 may execute commands or instructions onto a block in the memory device 150.

By way of example but not limitation, the host request manager (HRM) 46 may use the map manager (MM) 44 and the block manager 48 to handle or process requests according to read and program commands and events which are delivered from the host interface 132.

The host request manager (HRM) 46 may send an inquiry request to the map manager (MM) 44 to determine a physical address corresponding to a logical address which is entered with the events. The host request manager (HRM) 46 may send a read request with the physical address to the memory interface 142 to process the read request, i.e., handle the events. In one embodiment, the host request manager (HRM) 46 may send a program request (or a write request) to the block manager 48 to program data to a specific empty page storing no data in the memory device 150, and then may transmit a map update request corresponding to the program request to the map manager (MM) 44 in order to update an item relevant to the programmed data in information of mapping the logical and physical addresses to each other.

The block manager 48 may convert a program request delivered from the host request manager (HRM) 46, the map manager (MM) 44, and/or the state manager 42 into a flash program request used for the memory device 150, in order to manage flash blocks in the memory device 150. In order to maximize or enhance program or write performance of the memory system 110, the block manager 48 may collect program requests and send flash program requests for multiple-plane and one-shot program operations to the memory interface 142. In an embodiment, the block manager 48 sends several flash program requests to the memory interface 142 to enhance or maximize parallel processing of a multi-channel and multi-directional flash controller.

In one embodiment, the block manager 48 may manage blocks in the memory device 150 according to the number of valid pages, select and erase blocks having no valid pages when a free block is needed, and select a block including the least number of valid pages when it is determined that garbage collection is to be performed. The state manager 42 may perform garbage collection to move valid data stored in the selected block to an empty block and erase data stored in the selected block so that the memory device 150 may have enough free blocks (i.e., empty blocks with no data). When the block manager 48 provides information regarding a block to be erased to the state manager 42, the state manager 42 may check all flash pages of the block to be erased to determine whether each page of the block is valid.

For example, to determine validity of each page, the state manager 42 may identify a logical address recorded in an out-of-band (00B) area of each page. To determine whether each page is valid, the state manager 42 may compare a physical address of the page with a physical address mapped to a logical address obtained from an inquiry request. The state manager 42 sends a program request to the block manager 48 for each valid page. A map table may be updated by the map manager 44 when a program operation is complete.

The map manager 44 may manage map data, e.g., a logical-physical map table. The map manager 44 may process various requests, for example, queries, updates, and the like, which are generated by the host request manager (HRM) 46 or the state manager 42. The map manager 44 may store the entire map table in the memory device 150 (e.g., a flash/non-volatile memory) and cache mapping entries according to the storage capacity of the memory 144. When a map cache miss occurs while processing inquiry or update requests, the map manager 44 may send a read request to the memory interface 142 to load a relevant map table stored in the memory device 150. When the number of dirty cache blocks in the map manager 44 exceeds a certain threshold value, a program request may be sent to the block manager 48, so that a clean cache block is made and a dirty map table may be stored in the memory device 150.

When garbage collection is performed, the state manager 42 copies valid page(s) into a free block, and the host request manager (HRM) 46 may program the latest version of the data for the same logical address of the page and currently issue an update request. When the state manager 42 requests the map update in a state in which the copying of the valid page(s) is not completed normally, the map manager 44 might not perform the map table update. This is because the map request is issued with old physical information when the state manger 42 requests a map update and a valid page copy is completed later. The map manager 44 may perform a map update operation to ensure accuracy when, or only if, the latest map table still points to the old physical address.

FIG. 4 illustrates internal configuration of the controller shown in FIGS. 1 to 3 according to an embodiment of the disclosed technology.

Referring to FIG. 4, the flash translation layer (FTL) 240 in the controller 130 can be divided into three layers: an address translation layer ATL; a virtual flash layer VFL; and a flash Interface Layer FIL.

For example, the address translation layer ATL may convert a logical address LA transmitted from a file system into a logical page address. The address translation layer ATL can perform an address translation process regarding a logical address space. That is, the address translation layer ATL can perform an address translation process based on mapping information to which the logical page address LPA of the flash memory 140 is mapped to the logical address LA transmitted from the host. Such logical-to-logical address mapping information (hereinafter referred to as L2L mapping) may be stored in an area in which metadata is stored in the memory device 150.

The virtual flash layer VFL may convert the logical page address LPA, which is mapped by the address translation layer ATL, into a virtual page address VPA. Here, the virtual page address VPA may correspond to a physical address of a virtual memory device. That is, the virtual page address VPA may correspond to the memory block 60 in the memory device 150. If there is a bad block among the memory blocks 60 in the memory device 150, the bad block may be excluded by the virtual flash layer VFL. In addition, the virtual flash layer VFL can include a recovery algorithm for scanning a scan area to restore the logical-to-virtual address mapping information (L2V mapping) stored in the memory device 150 and mapping information in the data region for storing user data. The recovery algorithm can be capable of recovering the logical-to-virtual address mapping information (L2V mapping). The virtual flash layer VFL may perform an address conversion process regarding the virtual address space, based on the logical-to-virtual address mapping information (L2V mapping) restored through the recovery algorithm.

The flash interface layer FIL can convert a virtual page address of the virtual flash layer VFL into a physical page address of the memory device 150. The flash interface layer FIL performs a low-level operation for interfacing with the memory device 150. For example, the flash interface layer FIL can include a low-level driver for controlling hardware of the memory device 150, an error correction code (ECC) for checking and correcting an error in data transmitted from the memory device 150, and a module for performing operations such as Bad Block Management (BBM).

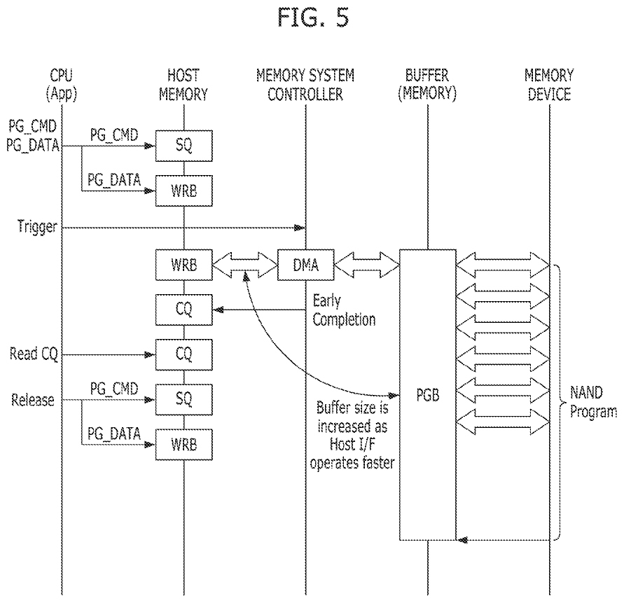

FIG. 5 illustrates a first example of data input/output operations between a host and a memory system in a data processing system according to another embodiment of the disclosed technology.

Referring to FIGS. 1 and 5, at least one program command PG_CMD and program data PG_DATA which are associated with a data input/output operation performed between the host 102 and the memory system 110 can be generated or issued by the central processing unit (CPU) or the application (App) 104 in the host 102. The program command PG_CMD may be stored in the submission queue SQ 167 in the host memory 106, and the program data PG_DATA may be stored in the write data buffer WRB 166 in the host memory 106. The host 102 (e.g., the central processing unit (CPU) or the application (App) 104) can notify the memory system 110 that the program command PG_CMD and the program data PG_DATA are stored in the host memory 106 (Trigger).

The controller 130 in the memory system 110 can include a direct memory access (DMA) control circuitry 162 for supporting direct memory access (DMA). After receiving a trigger regarding the program command PG_CMD and the program data PG_DATA from the host 102, the direct memory access (DMA) control circuitry 162 can access the host memory 106 to get or receive the program command PG_CMD or program data PG_DATA. After getting the program command PG_CMD, the controller 130 can store the program data PG_DATA in the data buffer (PGB) 164. After the program data PG_DATA is stored in the data buffer (PGB) 164, the direct memory access (DMA) control circuitry 162 in the memory system 110 can send the early completion signal E_C in the completion queue (CQ) 168 before the program operation regarding the corresponding program data PG_DATA is completed in the memory device 150.

Thereafter, the controller 130 may transmit the program data PG_DATA to the memory device 150, and the memory device 150 may program the program data PG_DATA in non-volatile memory cells. After the early completion signal E_C is included in the completion queue (CQ) 168, the host 102 can check an entry of the completion queue (CQ) 168 and recognize the early completion signal E_C included in the completion queue 168 (Read CQ). In response to the early completion signal E_C included in the completion queue (CQ) 168, the host 102 might release the program command PG_CMD stored in the submission queue (SQ) 167 and the program data PG_DATA included in the write data buffer (WRB) 166.

An operation speed of the program operation performed in the memory device 150 might be slower than those of other operations such as transmission of the program command PG_CMD and the program data PG_DATA between the central processing unit (CPU) or the application (App, 104) and the host memory 106 in the host 102, transmission of the program command PG_CMD and the program data PG_DATA between the host 102 and the memory system 110, saving of the program command PG_CMD and the program data PG_DATA in the data buffer (PGB) 164, and transmission of the program command PG_CMD and the program data PG_DATA between the controller 130 and the memory device 150. As a plurality of program commands PG_CMD and a large amount of the program data PG_DATA corresponding to the plurality of program commands PG_CMD are issued by the host 102 and transmitted to the memory system 110, a size of the program data PG_DATA stored in the data buffer (PGB) 164 in the memory system 110 can increase.

According to an embodiment, after the memory device 150 programs the program data PG_DATA into non-volatile memory cells, the memory device 150 can notify the controller 130 of program completion, and then the controller 130 can release the corresponding program data PG_DATA from the data buffer (PGB) 164. The controller 130 can send and add a completion signal regarding the program command PG_CMD corresponding to the program data PD_DATA to the completion queue (CQ) 168. The central processing unit (CPU) or the application (App) 104 in the host 102 can read the completion queue (CQ) 168 in the host memory 106 and release the corresponding program command PG_CMD from the submission queue (SQ) 167. In addition, the central processing unit (CPU) 104 or the application (App) 104 in the host 102 may release the program data PG_DATA stored in the program data buffer WRB. Due to a slow data input/output speed of the memory device 150, the host 102 may determine that data input/output performance of the memory system 110 is not good.

To solve this issue, the memory system 110 can transmit the early completion signal to the host 102 before the memory device 150 completes the program operation. However, referring to FIG. 5, as the number of program commands PG_CMD and an amount of program data PG_DATA generated by the host 102 increases, the program data PG_DATA stored in the data buffer (PGB) 164 in the memory system 110 can increase. As a size of the data buffer (PGB) 164 in the memory system 110 increases, more program data PG_DATA can be stored. However, the size of the data buffer (PGB) 164 in the memory system 110 is limited, and it might be difficult to expand or change internal resources of the memory system 110 (e.g., the size of the data buffer (PGB) 164).

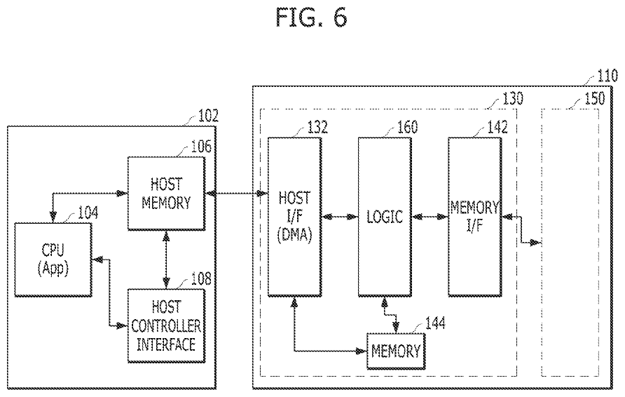

FIG. 6 illustrates an example of accessing a memory in a host of a memory system according to another embodiment of the disclosed technology.

Referring to FIG. 6, the host 102 may include a processor 104, a host memory 106, and a host controller interface 108. The memory system 110 may include a controller 130 and a memory device 150. The controller 130 and the memory device 150 described in FIG. 6 may be similar to the controller 130 and the memory device 150 described in FIGS. 1 to 3.

Hereinafter, the descriptions regarding the controller 130 and the memory device 150 as shown in FIG. 6 are focused on differences from the controller 130 and the memory device 150 as shown in FIGS. 1 to 3. Specifically, a logic block 160 in the controller 130 can correspond to the flash translation layer (FTL) 240 described with reference to FIGS. 3 to 4. In some embodiments, the logic block 160 in the controller 130 may further perform other roles and functions which are not described in the flash translation layer (FTL) 240.

In the host 102, the processor 104 may have higher performance than that of the memory system 110, and the host memory 106 may be capable of storing a larger amount of data than the memory system 110. The processor 104 and host memory 106 of the host 102 can have advantages in terms of space and upgrade. For example, the processor 104 and host memory 106 can have less space limitations than processor 134 and memory 144 in the memory system 110. The processor 104 and the host memory 106 can be upgraded to improve performance, which may be distinguishable from the processor 134 and the memory 144 in the memory system 110. In an embodiment, the memory system 110 can utilize the resources of the host 102 in order to increase operation efficiency of the memory system 110.

As an amount of data that the memory system 110 can store increases, an amount of data that the host 102 intends to store in the memory system 110 can also increase. An operation for programming data into non-volatile memory cells included in the memory device 150 of the memory system 110 can take longer than an operation for transferring data from the host 102 to the memory device 150.

Accordingly, an amount of data temporarily stored in the memory 144 before data is completely programmed in the memory device 150 can increase. However, as the amount of temporarily stored data increases, the operation of the controller 130 may be burdened because a space of the memory 144 is limited.

In some cases, the storage capability of the host memory 106 in the host 102 may be greater (e.g., by tens or hundreds of times) than that of the memory 144 in the controller 130. Accordingly, the memory system 110 may utilize a portion of the host memory 106 in the host 102 in order to overcome the limitation of storage capability of the memory 144 embedded in, or directly used by, the controller 130. Referring to FIGS. 1 and 2, the direct memory access (DMA) control circuitry 162 and the host interface 132 in the memory system 110 can directly access the host memory 106 in the host 102.

Direct memory access (DMA) can allow the memory system 110, which is an input/output (I/O) device, to send and receive data directly to and from the host memory 106 which is the main memory, so that a memory operation speed can be improved by bypassing the central processing unit (CPU) 104. The host interface 132 can include the direct memory access (DMA) control circuitry 162 including a DMA controller (DMAC) for handling a process for directly accessing the host memory 106. The host memory 106 may be accessed by the central processing unit 104, the memory system 110, or a peripheral device (e.g., the host controller interface 108). For example, when the host interface 132 in the memory system 110 attempts to access the host memory 106, the access of the host memory 106 is possible only with the support of the host controller interface 108, such as a peripheral device, without intervention of the central processing unit 104.

For direct memory access (DMA), the data processing system including the host 102 and the memory system 110 can use resources such as I/O addresses, memory addresses, interrupt request numbers (IRQ), and direct memory access (DMA) channels. At least one specific line of the bus can be assigned to, or allocated for, these resources.

The direct memory access channels (DMA channels) can be used for data communication between the memory system 110 and the host memory 106. Using the direct memory access channels (DMA channels), the host 102 and the memory system 110 can transfer data to each other to avoid that the central processing unit (CPU) 104 has workload overloads. Without the direct memory access channels (DMA channels), the central processing unit (CPU) 104 should copy all data and carry out read/write processes for transmission to a peripheral device or an input/output (I/O) device via the bus. While the central processing unit (CPU) 104 is involved in the transmission, the central processing unit (CPU) may not be able to perform other calculations or operations until the corresponding operation for the transmission is completed. On the other hand, when the direct memory access channels (DMA channels) are used, the central processing unit (CPU) 104 can process other tasks while data transfer is being performed.

For example, the host interface 132 of the memory system 110 can perform data communication with the host controller interface 108 in the host 102. Without support or invention of the central processing unit 104 in the host 102, the host memory 106 can be accessed. The host interface 132 may determine whether to get and store the program data PG_DATA in the memory 144 of the memory system 110, in response to an operation state of the memory 144. When it is determined that an available space in the memory 144 is insufficient, the host interface 132 can postpone or delay reception or acquisition of the program data PG_DATA until the available space is secured in the memory 144.

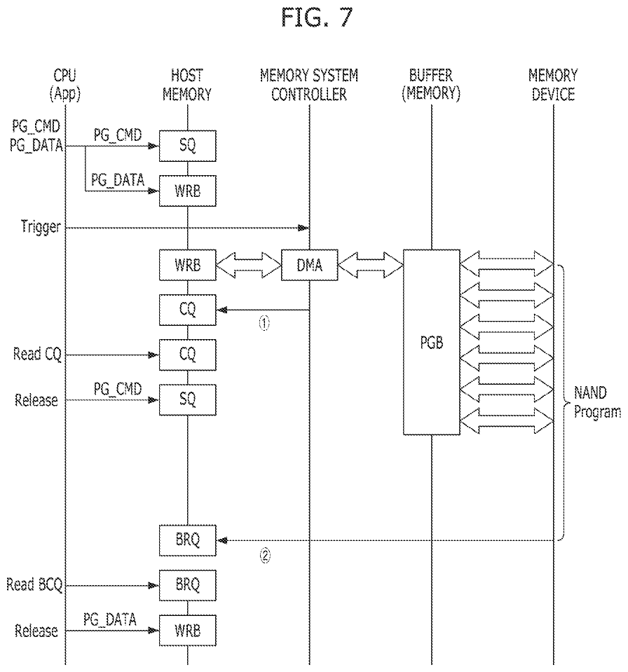

The controller 130 can obtain the program command PG_CMD and the program data PG_CMD included in the host memory 106 of the host 102, as well as send or add a request for releasing the program command PG_CMD and the program data PG_CMD from the host memory 106. Hereinafter, referring to FIG. 7, a procedure in which the memory system 110 improves data input/output performance operation based on an usage of the host memory 106 for the data input/output operation is described.

FIG. 7 illustrates a second example of data input/output operations between the host and the memory system in the data processing system according to another embodiment of the disclosed technology.

Referring to FIG. 7, at least one program command PG_CMD and program data PG_DATA which are associated with a data input/output operation performed between the host 102 and the memory system 110 can be generated or issued by the central processing unit (CPU) or the application (App) 104 in the host 102. The program command PG_CMD may be stored in the submission queue SQ 167 in the host memory 106, and the program data PG_DATA may be stored in the write data buffer WRB 166 in the host memory 106. The host 102 (e.g., the central processing unit (CPU) or the application (App) 104) can notify the memory system 110 that the program command PG_CMD and the program data PG_DATA are stored in the host memory 106 (Trigger).

The controller 130 in the memory system 110 may receive a trigger or a notification from the host 102 and then attempt to get or obtain the program command PG_CMD stored in the submission queue 167. In this case, if there is an available space in the data buffer (PGB) 164, the controller 130 may bring the program data PG_DATA stored in the write data buffer (WRB) 166 in the host memory 106. However, when the available space in the data buffer (PGB) 164 is insufficient, the controller 130 may not immediately retrieve the program data PG_DATA stored in the write data buffer (WRB) 166 in the host memory 106.

In the second example described in FIG. 7, unlike the first example shown in FIG. 5, after acquiring the program command PG_CMD stored in the submission queue (SQ) 167, the controller 130 in the memory system 110 can determine a timing of bring the program data PG_DATA from the write data buffer (WRB) 166 into the data buffer 164. Even if the program operation regarding the program data PG_DATA is not completed in the memory device 150 after the program data PG_DATA is stored in the data buffer 164, the controller 130 can send and add the early completion signal \textcircled{1} in the completion queue (CQ) 168 of the host memory 106. After reading the early completion signal \textcircled{1} included in the completion queue (CQ) 168 (Read CQ), the central processing unit (CPU) 104 of the host 102 can release the program command PG_CMD from the submission queue (SQ) 167, in response to the early completion signal \textcircled{1} included in the completion queue (CQ) 168. However, the central processing unit (CPU, 104) of the host 102 may not release the program data PG_DATA from the write data buffer (WRB) 166, for example, the program data PG_DATA in the write data buffer (WRB) 166 can be continuously maintained.

The controller 130 in the memory system 110 can include the direct memory access (DMA) control circuitry 162 for supporting direct memory access (DMA). When there is an available space in the data buffer (PGB) 164, the direct memory access (DMA) control circuitry 162 can access the host memory 106 in response to the program command PG_CMD obtained from the host 102 and retrieve the program data PG_DATA corresponding to the program command PG_CMD from the write data buffer (WRB) 166. The controller 130 may store the program data PG_DATA in the data buffer (PGB) 164.

An operation speed of the program operation performed in the memory device 150 might be slower than those of other operations such as transmission of the program command PG_CMD and the program data PG_DATA between the central processing unit (CPU) or the application (App, 104) and the host memory 106 in the host 102, transmission of the program command PG_CMD and the program data PG_DATA between the host 102 and the memory system 110, saving of the program command PG_CMD and the program data PG_DATA in the data buffer (PGB) 164, and transmission of the program command PG_CMD and the program data PG_DATA between the controller 130 and the memory device 150. As a plurality of program commands PG_CMD and a large amount of the program data PG_DATA corresponding to the plurality of program commands PG_CMD are issued by the host 102 and transmitted to the memory system 110, a size of the program data PG_DATA stored in the data buffer (PGB) 164 in the memory system 110 can increase. Because a size of storage capability in the data buffer 164 is limited, the direct memory access (DMA) control circuitry 162 can access and secure the program data PG_DATA, in response to an operation state of the data buffer 164 after acquiring the program command PG_CMD. When the program data PG_DATA may not be stored in the data buffer 164 of the memory system 110, the controller 130 can delay, determine, or control a timing of getting or bringing the program data PG_DATA stored in the data buffer (WRB) 166 of the host memory 106 until an available space is secured in the data buffer 164.

When the program data PG_DATA can be stored in the data buffer 164 of the memory system 110, the direct memory access (DMA) control circuitry 162 of the controller 130 can access the write data buffer (WRB) 166 in the host memory 106, get or retrieve the program data PG_DATA stored in the write data buffer (WRB) 166, and store the program data PG_DATA in the data buffer (PGB) 164. The controller 130 may transfer the program data PG_DATA stored in the data buffer (PGB) 164 to the memory device 150.

After the memory device 150 completes a program operation (NAND Program) regarding the program data PG_DATA, the memory device 150 can notify the controller 130 of the program completion. The controller 130 can send and include a buffer release request \textcircled{2} in the buffer release queue (BRQ) 169 in response to the program completion notified by the memory device 150. The central processing unit (CPU) or the application (App) 104 in the host 102 can check the buffer release queue (BRQ) 169 (Read BCQ), and then release or delete the program data PG_DATA stored in the write data buffer (WRB) 166.

In the embodiment described with reference to FIG. 7, the controller 130 in the memory system 110 may perform two different operations \textcircled{1}, \textcircled{2} in response to a single program command PG_CMD transmitted from the host 102. For example, after acquiring the program data PG_DATA corresponding to the program command PG_CMD, the memory system 110 can send and include the early completion signal \textcircled{1} in the completion queue (CQ) 168 in the host memory 106. The host 102 may control and manage the submission queue (SQ) 167 in response to the early completion signal \textcircled{1} included in the completion queue (CQ) 168 of the host memory 106. The memory system 110 can get or bring the program data PG_DATA corresponding to the program command PG_CMD from the program data buffer (WRB) 166 when internal resources can be allocated for the program operation. After the program data PG_DATA corresponding to the program command PG_CMD is programmed in the memory device 150, the memory system 110 can send or include the buffer release request \textcircled{2} in the buffer release queue (BRQ) 169 so that the host 102 can release the program data PG_DATA stored in the write data buffer (WRB) 166 of the host memory 106. The host 102 can establish the buffer release queue (BRQ) 169. The memory system 110 can send two different responses to the completion queue (CQ) 168 and the buffer release queue (BRQ), for releasing the program command PG_CMD and the program data PG_DATA from the submission queue 167 and the write data buffer (WRB) 166. This procedure can make the memory system 110 overcome a limitation of internal resources because the memory system 100 can use at least some of the host memory 106. Further, the host 102 can control or manage the host memory 106 based on divided responses of the memory system 110 regarding a single program command.

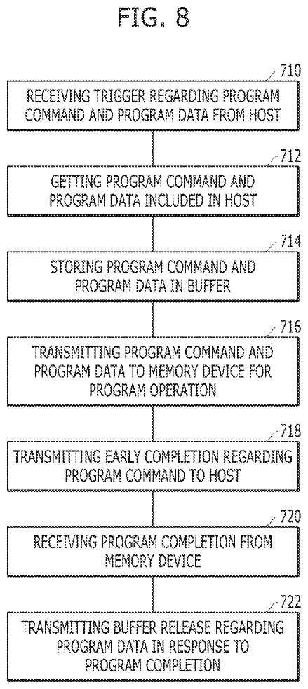

FIG. 8 illustrates a method of operating a memory system according to another embodiment of the disclosed technology. FIG. 8 illustrates an operation when there is an available space for storing the program data PG_DATA in the data buffer 164 in the memory system 110.

Referring to FIG. 8, the method of operating the memory system 110 includes receiving a trigger regarding a program command PG_CMD and program data PG_DATA from the host 102 (operation 710), getting or retrieving the program command PG_CMD and the program data PG_DATA from the host 102 (operation 712), and storing the program command in the command queue 56 and the program data PG_DATA in the data buffer 164 (operation 714). For example, the memory system 110 can access the host memory 106 to bring or obtain the program command PG_CMD from the submission queue (SQ) 167 in the host memory 106 and bring or obtain the program data PG_DATA from the write data buffer 166 in the host memory 106. When there is an available space for storing the program data PG_DATA in the data buffer 164 of the memory system 110, the memory system 110 can get the program data PG_DATA included in the write data buffer 166 in the host memory 106 and store the program data PG_DATA in the data buffer 164.

In addition, the method of operating the memory system can include transmits the program command PG_CMD and the program data PG_DATA to the memory device 150 to perform a program operation (operation 716). The controller 130 can transmit to the host 102 the early completion signal regarding the program command PG_CMD (operation 718). Even before the program operation is completed, the memory system 110 can send to the host 102 the early completion signal to satisfy data input/output performance requested by the host 102. At this time, the early completion signal can be sent by the controller 130 and included in the completion queue (CQ) 168 of the host memory 106.

Thereafter, in the method of operating the memory system, when the memory device 150 notifies the controller 130 of completion regarding the program operation (operation 720), the memory system 110 can notify the host 102 of releasing the program data PG_DATA stored in the write data buffer 166 in the host memory 106 (operation 722). For example, the memory system 110 can send and include a buffer release request corresponding to the corresponding program data in the buffer release queue 169.

In FIG. 8, it is assumed that there is an available space for storing the program data PG_DATA in the data buffer 164 of the memory system 110. However, the data buffer 164 in the memory system 110 might not have an available space for storing the program data PG_DATA in the data buffer 164 of the memory system 110. In this case, the memory system 110 can obtain only the program command PG_CMD from the host 102 and delay a timing of bringing the program data PG_DATA from the host 102. In response to the program command PG_CMD, the memory system 110 can notify the host 102 of the early completion signal even though the program data PG_DATA is not programmed yet in the memory device 150. Thereafter, in response to the operating state of the memory 144 or the data buffer 164 in the memory system 110, the controller 130 can bring or acquire the program data PG_DATA included in the write data buffer 166 in the host memory 106 and store the program data PG_DATA in the data buffer 164.

Here, the program command PG_CMD can include a location (e.g., an address in the write data buffer 166) of the program data PG_DATA that the host 102 would like to send to and store in the memory system 110. The controller 130 can include the direct memory access (DMA) control circuitry 162, so that the corresponding program data PG_DATA may be acquired or retrieved based on the location of the program data PG_DATA in response to availability of internal resources.

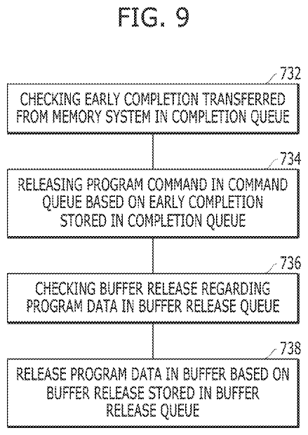

Meanwhile, the host 102 can establish the completion queue (CQ) 168 capable of storing the early completion signal transmitted by the memory system 110 and the buffer release queue (BRQ) 169 capable of storing the buffer release request transmitted by the memory system 110. The host 102 can check or read an entry in the completion queue 168 and the buffer release queue 169 to manage, delete, or control an entry in the submission queue 167 and the write data buffer 166. Operations of the host 102 will be described in detail with reference to FIG. 9.

FIG. 9 illustrates a method of operating a host according to another embodiment of the disclosed technology.

Referring to FIG. 9, the method of operating the host 102 can include checking the early completion signal transmitted from the memory system 110 in the completion queue (CQ) 168 (operation 732) and releasing a corresponding command (e.g., the program command PG_CMD) from the submission queue (SQ) 167 (operation 734). When the host 102 transmits the program command PG_CMD to the memory system 110, the memory system 110 can receive the program command PG_CMD and then notify the host 102 of the early completion signal (e.g., include the early completion signal in the completion queue (CQ) 168) even if the program operation corresponding to the program command PG_CMD is not completed in the memory device 150. When the host 102 checks or reads the early completion signal included in the completion queue (CQ) 168, the host 102 can delete the program command PG_CMD stored in the submission queue (SQ) 167 based on the early completion signal included in the completion queue (CQ) 168.

Further, the method of operating the host 102 can include checking or reading the buffer release request sent from the memory system 110 in the buffer release queue (BRQ) 169 (operation 736) and releasing or deleting the program data PG_DATA from the write data buffer 166 based on an entry (i.e., the buffer release request) included in the buffer release queue (BRQ) 169 (operation 738). As described with reference to FIG. 7, the memory system 110 can distinguish a time point at which the program command PG_CMD is acquired and a time point at which the program data PG_DATA corresponding to the program command PG_CMD is acquired. Further, the memory system 110 can send to the host 102 different responses for each of the program command PG_CMD and the program data PG_DATA. When the memory system 110 sends and includes the buffer release request in the buffer release queue 169 in the host 102, the host 102 can check or read an entry of the buffer release queue 169 and delete or release the program data PG_DATA corresponding to the buffer release request from the write data buffer 166 of the host memory 106.

As above described, a memory system according to an embodiment of the disclosure can improve data I/O performance while performing data I/O operations corresponding to commands input from an external device.

In addition, the memory system according to an embodiment of the disclosed technology can efficiently manage resources used in performing data input/output operations and suppress unnecessary consumption of resources to improve data input/output performance.

In addition, the memory system according to an embodiment of the disclosed technology can temporarily hold program data corresponding to a program command of the host in a shared memory within the host, so that efficiency of data input/output operations can be improved beyond limitation of resources included in the memory system.

While various embodiments have been described above, variations and improvements of the disclosed embodiments and other embodiments may be made based on what is described or illustrated in this document.

What is claimed is:

1. A data processing system, comprising:
a host configured to store a program command in a submission queue and store program data corresponding to the program command in a host data buffer; and
a memory system in communication with the host and configured to:
obtain the program data stored in the host data buffer based on an operation status of an internal buffer;
transmit an early completion signal to the host after obtaining the program data corresponding to the program command; and
transmit, to the host, a release request for releasing the program data from the host data buffer.

2. The data processing system according to claim 1, wherein the host comprises:
an application configured to generate the program command and the program data; and
at least one input/output (I/O) core configured to control at least one pair of the submission queue and a completion queue corresponding to the submission queue, and control at least one pair of the host data buffer and a buffer release queue corresponding to the host data buffer.

3. The data processing system according to claim 2, wherein the host is configured to send a notification regarding the program command and the program data to the memory system,
the at least one I/O core is configured to transfer information stored in the submission queue and the host data buffer to the memory system, and
the at least one I/O core is configured to release a command from the submission queue based on information stored in the completion queue, and release data from the host data buffer based on information stored in the buffer release queue.

4. The data processing system according to claim 1, wherein the memory system comprises:
a memory group including non-volatile memory cells;
a controller configured to transfer the program data from the host to the memory group via data communication; and
the internal buffer configured to temporarily store the program data.

5. The data processing system according to claim 4, wherein the memory group is configured to send a program completion signal regarding the program data in response to a completion of programming of the program data in the non-volatile memory cells.

6. The data processing system according to claim 5, wherein the controller is configured to release the program data from the internal buffer in response to the program completion signal.

7. The data processing system according to claim 5, wherein the controller is configured to release the program data from the internal buffer after sending the program data to the memory group regardless of the program completion signal.

8. The data processing system according to claim 7, wherein the controller is configured to monitor an available space in the internal buffer for determining the operation status of the internal buffer.

9. A memory system, comprising:
a storage device including plural non-volatile memory cells and configured to perform a data input/output operation; and
a controller in communication with the storage device and an external device and configured to control the data input/output operation, and
wherein the controller is further configured to send an early completion signal to the external device in response to obtaining program data corresponding to a program command and send, to the external device, a release request for releasing the program data after the storage device completes a program operation regarding the program data.

10. The memory system according to claim 9, wherein the storage device is configured to send a program completion signal regarding the program data after programming the program data in the plural non-volatile memory cells.

11. The memory system according to claim 10, wherein the controller is further configured to release the program data from the internal buffer in response to the program completion signal.

12. The memory system according to claim 10, wherein the controller is further configured to release the program data from the internal buffer after sending the program data to the memory group, regardless of the program completion signal.

13. The memory system according to claim 9, wherein the controller is further configured to store the early completion signal in a first region in the external device the release request in a second region in the external device.

14. The memory system according to claim 9, wherein the controller is further configured to monitor an available space of an internal memory to determine an operation state of the internal memory, and determine a timing that the program data is obtained from the external device in response to the operation state.

15. A memory system, comprising:
a memory device, including plural non-volatile memory cells, configured to perform a data input/output operation;
an internal memory configured to temporarily store data associated with the data input/output operation; and
a controller configured to obtain a program command associated with program data from an external device, determine a timing for obtaining the program data from the external device based on an operation state of the internal memory, send an early completion signal regarding the program data to the external device, and send a release request for releasing the program data to the external device after the program data is programmed in the plural non-volatile memory cells.

16. The memory system according to claim 15, wherein the controller is configured to:
obtain the program command from a first region of the external device;
obtain the program data from a second region of the external device;
store the early completion signal in a third region of the external device; and
store the release request in a fourth region of the external device.

17. The memory system according to claim 15, wherein the controller is further configured to monitor an available space in the internal buffer for determining the operation status of the internal buffer.

18. The memory system according to claim 15, wherein the controller is further configured to release the program data from the internal buffer after sending the program data to the memory device, regardless of the program completion signal.

19. The memory system according to claim 15, wherein the controller is further configured to release the program data from the internal buffer in response to the program completion signal.

20. The memory system according to claim 15, wherein the controller is configured to send an early completion signal to the external device after obtaining the program data from the external device.
